(19) United States
(12) Patent Application Publication
(10) Pub. No.: US 2022/0062725 A1
(43) Pub. Date: Mar. 3, 2022

(54) BAT FITTING

(71) Applicant: TRUE TEMPER SPORTS, INC., Memphis, TN (US)

(72) Inventors: Todd Darin HARMAN, Rossmoor, CA (US); Nathaniel Joel RADCLIFFE, Lake Oswego, OR (US); Tyler Elias DAILY, San Diego, CA (US); Jonathan James ERREDGE, La Mesa, CA (US); Donald Collins BROWN, Jr., San Diego, CA (US)

(73) Assignee: TRUE TEMPER SPORTS, INC., Memphis, TN (US)

(21) Appl. No.: 17/414,083

(22) PCT Filed: Jan. 2, 2020
(86) PCT No.: PCT/US2020/012067

§ 371 Date: Jun. 15, 2021

Related U.S. Application Data
(60) Provisional application No. 62/787,879, filed on Jan. 3, 2019.

(51) Int. Cl. A63B 60/42; A63B 71/06; G06F 3/0482

(52) U.S. Cl. CPC A63B 60/42; A63B 2102/18; G06F 3/0482; A63B 71/0622

(57) ABSTRACT

A system for fitting a bat to an athlete includes: a host control module configured to generate a graphical user interface including: an age field for input of a present age of the athlete; a height field for input of a present height of the athlete; a weight field for input of a present weight of the athlete; an association field for input of one of a league and a group with which the athlete is affiliated; a bat selection module configured to: determine a target drop based on data in the association field; determine a suggested bat length for the athlete based on data in the age, height, weight, and association fields; and determine a suggested bat weight based on the suggested bat length minus the target drop; and select one of a plurality of bats based on the suggested bat length and the suggested bat weight.

### CROSS-REFERENCE TO RELATED APPLICATIONS

The present disclosure is a PCT International Application of U.S. Provisional Patent Application No. 62/787,879 filed on Jan. 3, 2019. The entire disclosure of the application referenced above is incorporated herein by reference.

### FIELD

The present disclosure relates to athletic bats and more particularly to systems and methods for fitting a bat to an athlete.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Coaches, parents, and athletes desire baseball and softball bats that have mass, geometry, flexural, energy transfer, friction, acoustic, aesthetic, tactile, vibration damping, handle geometry, and other key properties that support their performance goals in both practice and game environments. Bat selection methodologies for an athlete may be based solely on the athlete's age, height, weight, and governing body for their particular league(s). While this may provide a directionally accurate bat fit, it does not take into account the particular performance goals that the athlete is working to achieve or the strength, speed, swing biomechanics, launch conditions, subsequent ball flight, or current performance of the athlete.

### SUMMARY

In a feature, a bat fitting system for fitting a bat to an athlete includes: a host control module configured to generate a graphical user interface (GUI) for display on a display, the GUI including: an age field for input indicative of a present age of the athlete; a height field for input indicative of a present height of the athlete; a weight field for input indicative of a present weight of the athlete; an association field for input indicative of one of a league and a group with which the athlete is affiliated; a bat selection module configured to: determine a target drop for bats for the athlete based on data in the association field; determine a suggested bat length for the athlete based on data in the age, height, weight, and association fields; and determine a suggested bat weight based on the suggested bat length minus the target drop; and select one of a plurality of bats based on the suggested bat length and the suggested bat weight, where the host control module is further configured to display the selected one of the plurality of bats on the GUI.

In further features, the bat selection module is configured to determine the suggested bat length using one of a lookup table and an equation that relates ages, heights, and weights for affiliations to suggested bat lengths.

In further features, the bat selection module is configured to set the target drop using a lookup table that relates possible affiliations in the association field to target drops.

In further features: the GUI further includes: a priority adjustment field for input indicative of a parameter of the athlete to prioritize; and a priority performance characteristic field for input indicative of an extent to improve the parameter to prioritize; where the bat selection module is further configured to: determine a final suggested bat length based on the suggested bat length, the parameter to prioritize, and a predetermined value corresponding to the input indicative of the extent to improve the parameter to prioritize; and select one of the plurality of bats based on the final suggested bat length; and where the host control module is further configured to display the final suggested bat length on the GUI.

In further features, the bat selection module is configured to determine the final suggested bat length based on: baseline+(P1 scalar*Modifier scalar 1*modifier 1) where baseline is the suggested bat length, P1 scalar is a predetermined scalar value, Modifier scalar 1 is the predetermined value corresponding to the input indicative of the extent to improve the parameter to prioritize, and modifier 1 is a predetermined value corresponding to a change in bat length to adjust the parameter by a predetermined amount.

In further features: the GUI further includes: a priority adjustment field for input indicative of a parameter of the athlete to prioritize; and a priority performance characteristic field for input indicative of an extent to improve the parameter to prioritize; where the bat selection module is further configured to: determine a final suggested bat weight based on the suggested bat weight, the parameter to prioritize, and a predetermined value corresponding to the input indicative of the extent to improve the parameter to prioritize; and select one of the plurality of bats based on the final suggested bat weight; and where the host control module is further configured to display the final suggested bat weight on the GUI.

In further features, the bat selection module is configured to determine the final suggested bat weight based on: baseline+(P1 scalar*Modifier scalar 1*modifier 1) where baseline is the suggested bat weight, P1 scalar is a predetermined scalar value, Modifier scalar 1 is the predetermined value corresponding to the input indicative of the extent to improve the parameter to prioritize, and modifier 1 is a predetermined value corresponding to a change in bat weight to adjust the parameter by a predetermined amount.

In further features: the GUI further includes: a priority adjustment field for input indicative of a parameter of the athlete to prioritize; and a priority performance characteristic field for input indicative of an extent to improve the parameter to prioritize; where the bat selection module is further configured to: determine a final suggested bat length based on the suggested bat length, the parameter to prioritize, and a predetermined value corresponding to the input indicative of the extent to improve the parameter to prioritize; determine a final suggested bat weight based on the suggested bat weight, the parameter to prioritize, and the predetermined value corresponding to the input indicative of the extent to improve the parameter to prioritize; and select one of the plurality of bats based on the final suggested bat length; and where the host control module is further configured to display the final suggested bat length and the final suggested bat weight on the GUI.

In further features, the bat selection module is configured to: determine the final suggested bat length based on: baseline l+(P1l scalar*Modifier scalar 1* modifier 1l) where baseline l is the suggested bat length, P1l scalar is a predetermined length scalar value, Modifier scalar 1 is the predetermined value corresponding to the input indicative of the extent to improve the parameter to prioritize, and modifier 1l is a first predetermined value corresponding to a change in bat length to adjust the parameter by a first predetermined amount; and determine the final suggested bat weight based on: baseline w+(P1w scalar*Modifier scalar 1*modifier 1w) where baseline w is the suggested bat weight, P1w scalar is a predetermined weight scalar value, Modifier scalar 1 is the predetermined value corresponding to the input indicative of the extent to improve the parameter to prioritize, and modifier 1w is a second predetermined value corresponding to a change in bat weight to adjust the parameter by a second predetermined amount.

In further features: the graphical user interface further includes a bat speed field for input indicative of a bat speed of the athlete; and the parameter of the athlete to prioritize includes bat speed.

In further features: the graphical user interface further includes a hand speed field for input indicative of a hand speed of the athlete; and the parameter of the athlete to prioritize includes hand speed.

In further features: the graphical user interface further includes a time to contact field for input indicative of a time to contact of the athlete; and the parameter of the athlete to prioritize includes time to contact.

In further features: the graphical user interface further includes a bat angle field for input indicative of a bat angle of the athlete; and the parameter of the athlete to prioritize includes bat angle.

In further features: the graphical user interface further includes an exit velocity field for input indicative of a exit velocity of the athlete; and the parameter of the athlete to prioritize includes exit velocity.

In further features: the graphical user interface further includes a smash factor field for input indicative of a smash factor of the athlete; and the parameter of the athlete to prioritize includes smash factor.

In further features: the graphical user interface further includes a launch angle field for input indicative of a launch angle of a ball at impact of the athlete; and the parameter of the athlete to prioritize includes launch angle.

In further features: the graphical user interface further includes a spin rate field for input indicative of a spin rate of a ball after impact of the athlete; and the parameter of the athlete to prioritize includes spin rate.

In further features: the graphical user interface further includes a flight angle field for input indicative of a flight angle of a ball after impact of the athlete; and the parameter of the athlete to prioritize includes flight angle.

In further features: the GUI further includes: a second priority adjustment field for input indicative of a second parameter of the athlete to prioritize; and a second priority performance characteristic field for second input indicative of an extent to improve the second parameter to prioritize; and where the bat selection module is further configured to: determine the final suggested bat length based on the suggested bat length, the parameter to prioritize, the second parameter to prioritize, the predetermined value corresponding to the input indicative of the extent to improve the parameter to prioritize, and a second predetermined value corresponding to the second input indicative of the extent to improve the second parameter to prioritize; and determine a final suggested bat weight based on the suggested bat length, the parameter to prioritize, the second parameter to prioritize, the predetermined value corresponding to the input indicative of the extent to improve the parameter to prioritize, and a second predetermined value corresponding to the second input indicative of the extent to improve the second parameter to prioritize.

In further features, the bat selection module is configured to: determine the final suggested bat length based on: baseline l+(P1l scalar*Modifier scalar 1* modifier 1l)+(P2l scalar*Modifier scalar 2*modifier 2l) where baseline l is the suggested bat length, P1l scalar is a first predetermined length scalar value, Modifier scalar 1 is the predetermined value corresponding to the input indicative of the extent to improve the parameter to prioritize, modifier 1l is a third predetermined value corresponding to a change in bat length to adjust the parameter by a first predetermined amount, P2l scalar is a second predetermined length scalar value, Modifier scalar 2 is the second predetermined value corresponding to the second input indicative of the extent to improve the second parameter to prioritize, and modifier 2l is a fourth predetermined value corresponding to a change in bat length to adjust the second parameter by a second predetermined amount; and determine the final suggested bat weight based on: baseline w+(P1w scalar*Modifier scalar 1*modifier 1w)+(P2w scalar*Modifier scalar 2*modifier 2w) where baseline l is the suggested bat weight, P1w scalar is a first predetermined weight scalar value, Modifier scalar 1 is the predetermined value corresponding to the input indicative of the extent to improve the parameter to prioritize, modifier 1w is a fifth predetermined value corresponding to a change in bat length to adjust the parameter by a third predetermined amount, P2w scalar is a second predetermined weight scalar value, Modifier scalar 2 is the second predetermined value corresponding to the second input indicative of the extent to improve the second parameter to prioritize, and modifier 2w is a sixth predetermined value corresponding to a change in bat length to adjust the second parameter by a fourth predetermined amount.

In a feature, a method for fitting a bat to an athlete includes: by one or more processors, generating a graphical user interface (GUI) for display on a display, the GUI including: an age field for input indicative of a present age of the athlete; a height field for input indicative of a present height of the athlete; a weight field for input indicative of a present weight of the athlete; an association field for input indicative of one of a league and a group with which the athlete is affiliated; by the one or more processors, determining a target drop for bats for the athlete based on data in the association field; by the one or more processors, determining a suggested bat length for the athlete based on data in the age, height, weight, and association fields; by the one or more processors, determining a suggested bat weight based on the suggested bat length minus the target drop; by the one or more processors, selecting one of a plurality of bats based on the suggested bat length and the suggested bat weight; and by the one or more processors, displaying the selected one of the plurality of bats on the GUI.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example bat fitting system;

FIGS. 2A-2C are an example of a graphical user interface used to input and recommend a bat to an athlete; and

FIG. 3 is a flowchart depicting an example method of providing a suggested bat, bat length, and bat weight.

In the drawings, reference numbers may be reused to identify similar and/or identical elements.

### DETAILED DESCRIPTION

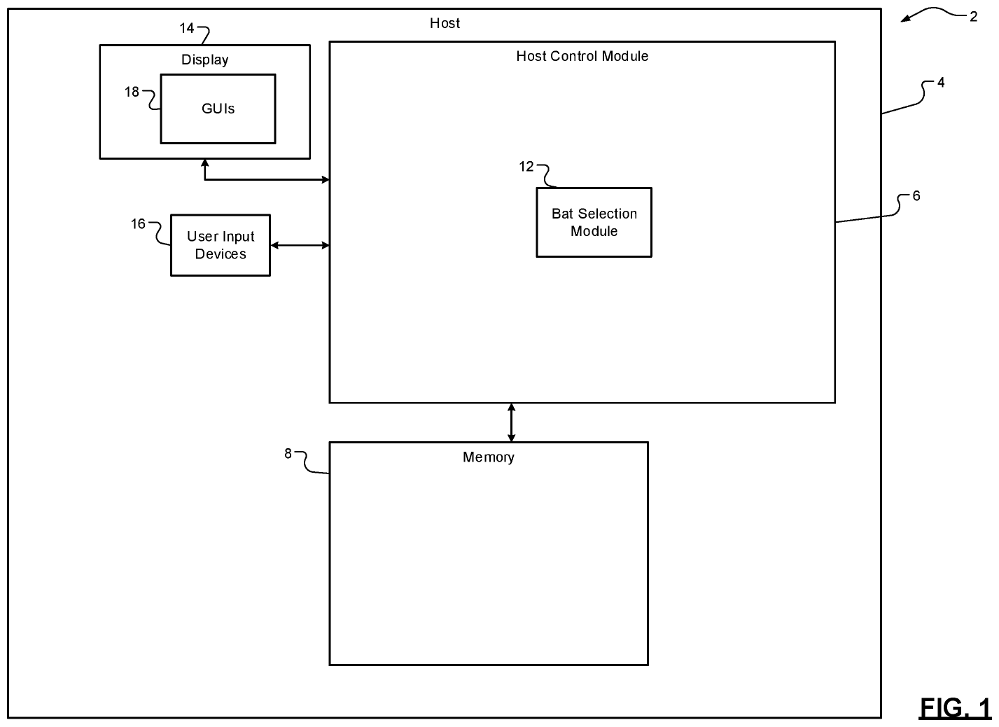

FIG. 1 includes a functional block diagram of an example bat fitting system. A host 4 includes a host control module 6 and memory 8. The memory 8 may be remotely located from the host 4 and accessed via a network (e.g., the Internet) or may be located within the host 4, as shown.

The host control module 6 includes a bat selection module 12. The bat selection module 12 selects a bat, bat length, and bat weight based on user input from one or more user input devices 16. In various implementations, the bat selection module 12 may select a bat, bat length, and bat weight from a group consisting of bats manufactured by only one bat manufacturer.

One or more graphical user interfaces (GUIs) 18 generated by the host control module 6 may be displayed for a user via a display 14. Examples of the user input devices 16 include, for example, a pointing device (e.g., a mouse, pen and tablet, touch screen, etc.), a keyboard, and/or one or more other suitable devices. The display 14 may include a user input device in various implementations, such as in the case of the display 14 including a touch screen display. The display 14 may include, for example, a monitor, a projector, or another suitable displaying device.

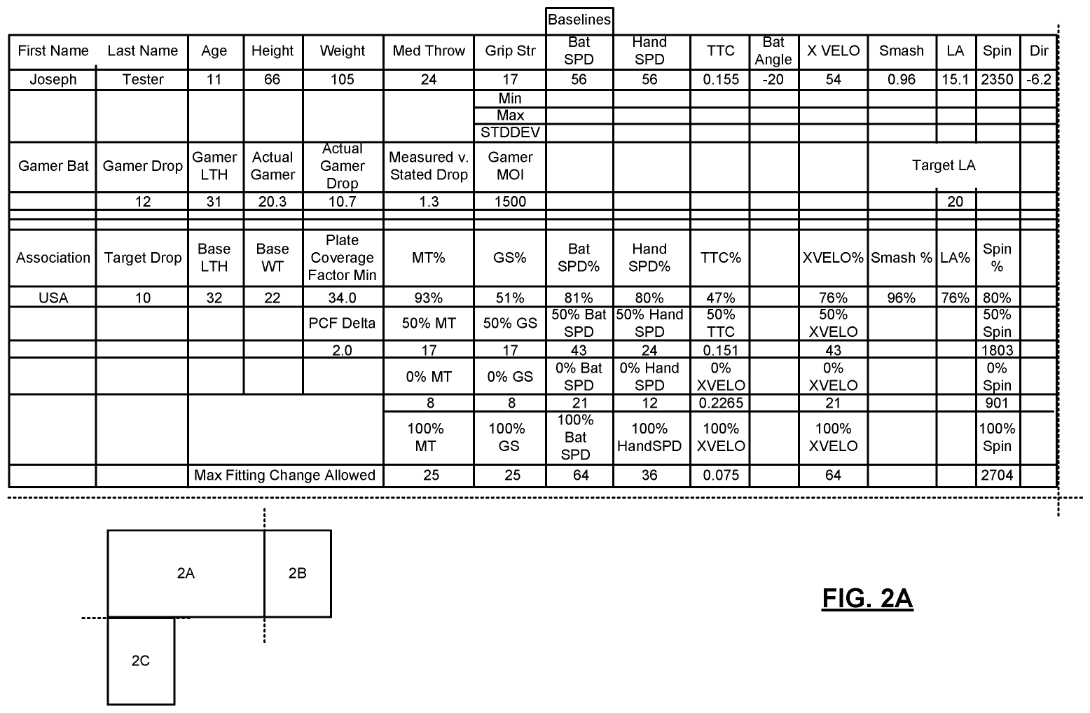

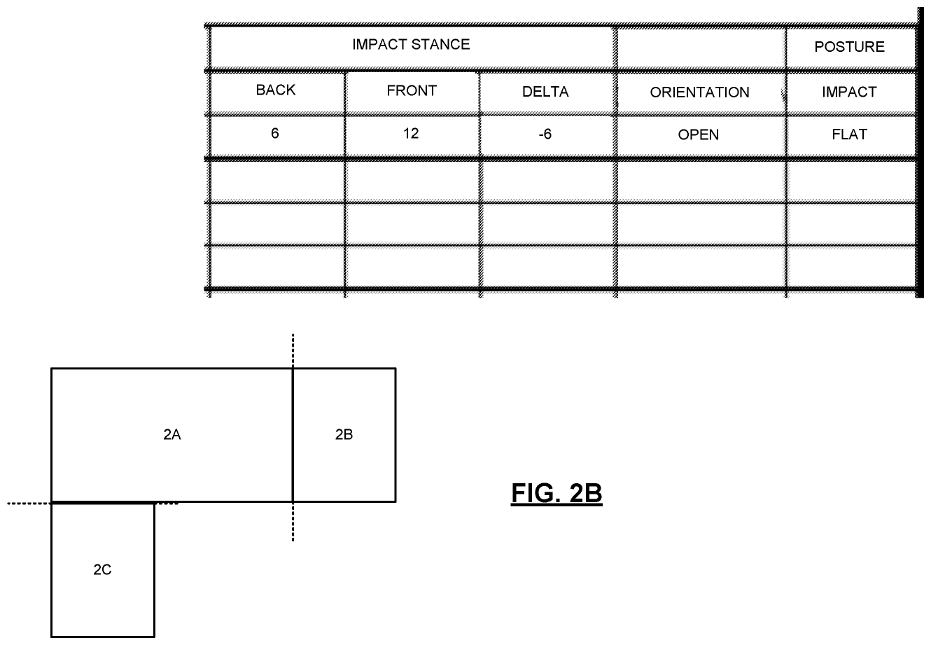

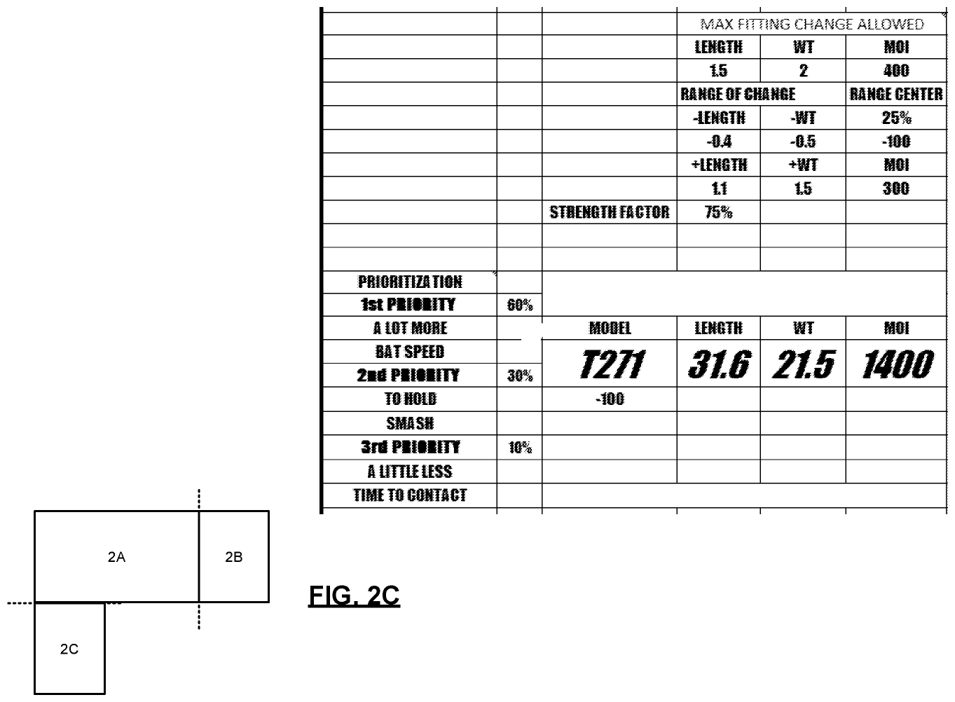

FIGS. 2A-2C include an example illustration of the graphical user interface 18 for fitting a bat to an athlete. The bat selection module 12 displays the graphical user interface 18 on the display 14 and receives user input for generating a bat selection from the graphical user interface 18. Initially, the bat selection module 12 may generate the graphical user interface 18 empty with all fields empty. In various implementations, the display 14 (and another computing device) may be located remotely and the host 4 may act as a server and serve the following bat fitting to the other computing device.

The graphical user interface 18 may include a first name field (“first name”) for user input of a first name of an athlete (or user). The graphical user interface 18 may include a last name field (“last name”) for user input of a last name of the athlete. The graphical user interface 18 includes an age field (“age”) for user input of a present age of the athlete. The graphical user interface 18 includes a height field (“height”) and weight field (“weight”) for user input of a present height and a present weight, respectively, of the athlete.

The graphical user interface 18 also includes a throwing distance field (“med throw”) and grip strength field (“grip str”) for user input of a distance that the athlete threw a medicine ball of a predetermined weight and a grip strength value of the athlete, respectively. The grip strength value may be, for example, a value between 0 and 100 (or a higher or lower value, such as 1,000,000) and increase as an athletes grip strength increases and vice versa. The grip strength value may be measured, for example, using a grip strength measurement device. The distance that the athlete threw the medicine ball may be measured, for example, using a ruler or another suitable type of measurement device. While the examples of throwing distance and grip strength are provided, one or more other measurements of strength and skill of an athlete may additionally or alternatively be used to further refine the data associated with athlete assessments.

The graphical user interface 18 also includes a bat speed field (“bat spd”) and hand speed field (“hand spd”) for user input of a bat speed and a hand speed of the athlete, respectively. The bat speed may be an average speed of a bat at impact with a ball over a predetermined number (e.g., 5) of swings of the bat by the athlete (e.g., sum of speed of bat at impact of each of the predetermined number of swings of the bat divided by the predetermined number of swings). The speed of the bat at impact may be measured, for example, using a speed measurement device (e.g., a radar based speed sensor). The hand speed may be an average speed of hands of the athlete at impact of the bat with the ball over the predetermined number (e.g., 5) of swings of the bat by the athlete (e.g., sum of speed of hands at impact of each of the predetermined number of swings of the bat divided by the predetermined number of swings). The speed of the hands of the athlete at impact may be measured, for example, using a speed measurement device (e.g., a radar based speed sensor). Other examples of speed measurement devices include image motion capture devices, accelerometers, rate gyroscopes, etc.

The graphical user interface 18 also includes a time to contact field (“TTC”) and a bat angle field (“bat angle”) for user input of a time to contact and a bat angle of the athlete, respectively. The time to contact may be an average time to contact of the athlete over the predetermined number (e.g., 5) of swings of the bat by the athlete (e.g., sum of the athlete's time to contact of each of the predetermined number of swings of the bat divided by the predetermined number of swings). The time to contact of a swing may refer to the period between when the athlete begins to swing the bat and when the athlete makes contact with the bat. The time to contact may be measured, for example, using a timer, a sensor, a motion capture system, or another suitable type of time measurement device. The bat angle may be an average bat angles of the athlete at impact of the bat with the ball over the predetermined number (e.g., 5) of swings of the bat by the athlete (e.g., sum of bat angle at impact of each of the predetermined number of swings of the bat divided by the predetermined number of swings). The bat angle may refer to the angle between a plane that is parallel with the ground and a vertical plane of the bat. Bat angle may be measured, for example, using images captured using a camera.

The graphical user interface 18 also includes an (ball) exit velocity field (“X velo”) and a smash factor field (“smash”) for user input of an exit velocity of the ball and a smash factor of the athlete, respectively. The exit velocity may be an average exit velocity of the ball after contact by the athlete over the predetermined number (e.g., 5) of swings of the bat by the athlete (e.g., sum of the exit velocities of each of the predetermined number of swings of the bat divided by the predetermined number of swings). The exit velocity may be measured, for example, using a speed measurement device (e.g., a radar based speed sensor). The bat selection module 12 may set the value in the smash factor field based on or equal to the athlete's exit velocity divided by the athlete's bat speed.

The graphical user interface 18 also includes a launch angle field (“LA”), a spin rate field (“spin”), and a ball flight angle (“dir”) for user input of a launch angle of the ball at impact, a spin rate of the ball after contact, and a flight angle of the ball at impact for the athlete, respectively. The launch angle may be an average launch angle of the ball after contact over the predetermined number (e.g., 5) of swings of the bat by the athlete (e.g., sum of the launch angles of each of the predetermined number of swings of the bat divided by the predetermined number of swings). The launch angle may refer to the angle between a plane that is parallel with the ground and a plane of the ball flight. The launch angle may be measured, for example, using images captured using a camera. The spin rate may be an average spin rate (e.g., in revolutions per minute) of the ball around a known, calculated, or stated spin axis after contact over the predetermined number (e.g., 5) of swings of the bat by the athlete (e.g., sum of the spin rates of each of the predetermined number of swings of the bat divided by the predetermined number of swings). The spin rate may be measured, for example, using images captured using a camera. The flight angle may be an average flight angle of the ball after contact over the predetermined number (e.g., 5) of swings of the bat by the athlete (e.g., sum of the flight angles of each of the predetermined number of swings of the bat divided by the predetermined number of swings). Flight angle may refer to an angle between a plane through the point of home plate and the center of the leading edge of home plate and a vertical plane tracking ball flight. The flight angle may be measured, for example, using images captured using a camera. The fitting may be tuned to fit spin axis and/or axis of ball rotation post-impact.

As shown in FIG. 2B, the graphical user interface 18 also includes a back foot distance to plate field (“back”) and a front foot distance to plate field (“front”) for user input of a pre-swing distance (e.g., in inches) between the back foot of the athlete and a line that follows the closest edge of the plate to the athlete and a pre-swing distance (e.g., in inches) between the front foot of the athlete and the line, respectively. The exit velocity may be measured, for example, using a distance measurement device (e.g., a ruler) or using images captured using a camera. For right handed batters, the left foot is the front foot and the right foot is the back foot. For left handed batters, the right foot is the front foot and the left foot is the back foot.

The graphical user interface 18 also includes a delta field. The delta field includes a value that is set based on or equal to the value in the front foot distance to plate field and the value in the back foot distance to plate field. The bat selection module 12 may set the value of the delta field based on or equal to the value in the front foot distance to plate field and the value in the back foot distance to plate field.

The graphical user interface 18 also includes an orientation field (“orientation”) and an impact posture (“impact”) field. The orientation field includes an indicator of whether the athlete has a pre-swing open stance, a closed stance, or a neutral stance. The bat selection module 12 may set the indicator based on the value of the delta field. For example, the bat selection module 12 may set the indicator to indicate an open stance when the value of the delta field indicates that the front foot of the athlete is further from the line than the back foot of the athlete. The bat selection module 12 may set the indicator to indicate a closed stance when the value of the delta field indicates that the back foot of the athlete is further from the line than the front foot of the athlete. The bat selection module 12 may set the indicator to indicate a neutral stance when the value of the delta field indicates that the front foot of the athlete and the back foot of the athlete are approximately the same distance from the line. The impact posture field includes an indicator of whether the athlete has a flat, standard, or upright posture at impact. The bat selection module 12 may set the indicator based on the value of the bat angle field. For example, the bat selection module 12 may set the indicator to indicate a flat posture when the value of the bat angle field is within a first predetermined angle range. The bat selection module 12 may set the indicator to indicate a standard posture when the value of the bat angle field is within a second predetermined angle range. The bat selection module 12 may set the indicator to indicate an upright posture when the value of the bat angle field is within a third predetermined angle range. The first, second, and third predetermined angle ranges may be mutually exclusive of each other as to not overlap.

The values of the fields above may be input by a user (via the user input devices 16). In various implementations, values for some of the fields may be obtained from an external data source that stores athlete data. For example only, the bat selection module 12 may obtain one or more of the values from one or more external data sources by querying the external data source(s) with the first and last name of the athlete. The age of the athlete may also be included in the query. In response to the query, the external data source(s) may respond with stored values associated with the athlete.

As shown in FIG. 2A, the graphical user interface 18 also includes an association field (“association”) that indicates a league or group with which the athlete is affiliated. Each league and group has its own rules regarding drop of bats. Drop may refer to the relationship between bat length and bat weight. For example, drop Y (Y being an integer greater than 0) may refer to a bat having a length of X (e.g., inches) has a minimum weight (mass) of X−Y (X minus Y, e.g., in ounces). For example, 2 may refer to a bat having a length of 31 inches having a minimum weight of 29 ounces. Drop dictates the minimum weight of a bat given the length of the bat.

The bat selection module 12 sets the value of a target drop field (“target drop”) of the graphical user interface 18 based on the indicator in the association field. For example, the bat selection module 12 may set the value of the target drop field using a lookup table that relates associations to target drops.

The graphical user interface 18 also includes a baseline bat length field (“base lth”) and a baseline bat weight field (“base wt”). The baseline bat length field includes a value indicative of a baseline suggested bat length for the athlete. The bat selection module 12 determines the value of the baseline suggested bat length, for example, based on the values of the age, height, weight, and association fields. For example only, the bat selection module 12 may determine the value of the baseline suggested bat length using one of a lookup table and an equation that relates ages, heights, and/or weights for an association to baseline suggested bat lengths. The bat selection module 12 sets the value of the baseline bat weight field based on or equal to the value of the baseline bat length field minus the value of the target drop field. The baseline bat weight and the baseline bat length are used below to determine a final suggested bat length and a final suggested bat weight. An example equation may be a polynomial 3 dimensional (3D) surface equation. Use of such an equation may be more accurately and efficiently (e.g., computationally) than a lookup table.

As shown in FIG. 2C, the graphical user interface 18 also includes a strength factor field (“strength factor”). The strength factor field includes a value indicative of the strength of the athlete relative to other athletes of the same age as the athlete. The bat selection module 12 sets the value of the strength factor field based on the value of the throwing distance field and the value of the grip strength field. For example, the bat selection module 12 may set the value of the strength factor field using one of a lookup table and an equation that relates values of throwing distance and grip strength to values of strength factor. In various implementations, the value indicative of the strength factor may be a percentage that ranges between 0 and 100 percent where 0 percent is indicative of the athlete being relatively weak relative to other athletes of the same age and 100 percent is indicative of the athlete being relatively strong and/or skilled relative to other athletes of the same age. The bat selection module 12 may set the value of the strength factor field additionally or alternatively based on launch monitor measurements of bat and ball performance (e.g., bat speed, exit velocity, etc.).

The graphical user interface 18 also includes an allowed (bat) length change field “length”, an allowed (bat) weight change field (“WΔT”), and may include an allowed (bat) moment of inertia (MOI) change field (“MOI”). The value of the allowed length change field indicates a maximum allowed change in length relative to the baseline bat length. In other words, the value of the allowed length change field indicates a maximum allowed difference between the baseline bat length and the final suggested bat length. The value of the allowed weight change field indicates a maximum allowed change in weight relative to the baseline bat weight. In other words, the value of the allowed weight change field indicates a maximum allowed difference between the baseline bat weight and the final suggested bat weight. The value of the allowed MOI change field indicates a maximum allowed change in MOI relative to the present bat of the athlete. In other words, the value of the allowed MOI change field indicates a maximum allowed difference between the MOI of the bat suggested and the athlete's present bat. The values of the allowed length of change field, the allowed weight change field, and the allowed MOI change field may be fixed predetermined values that are automatically populated. In various implementations, the bat selection module 12 may set the values of the allowed length of change field, the allowed weight change field, and the allowed MOI change field, for example, based on the strength factor of the athlete. The bat selection module 12 may determine the values of the allowed length of change field, the allowed weight change field, and the allowed MOI change field, for example, using one of an equation and a lookup table that relates strength factor values to values of these fields. While the example of an allowed MOI change field is provided, an allowed bat swingweight change and/or an allowed bat balance point change may be used additionally or alternatively.

The graphical user interface 18 also includes an allowed length decrease field “−length” and an allowed length increase field “+length”. The value of the allowed length decrease field indicates a maximum allowed decrease in length relative to the baseline bat length. In other words, the value of the allowed length decrease field indicates a maximum allowed amount that the final suggested bat length can be less than the between the baseline bat length. The value of the allowed length increase field indicates a maximum allowed increase in length relative to the baseline bat length. In other words, the value of the allowed length increase field indicates a maximum allowed amount that the final suggested bat length can be greater than the between the baseline bat length. The bat selection module 12 sets the values of the allowed length decrease field and the allowed length increase field based on the value of the strength factor field and the value of the allowed length change field. The bat selection module 12 may set the values of the allowed length decrease field and the allowed length increase field, for example, using one or more functions or equations that relate values of the strength factor field to values of the allowed length decrease field and the allowed length increase field. For example, the bat selection module 12 may set the values of the allowed length decrease field and the allowed length increase field using the equations:

allowed length decrease=1−strength factor*allowed length change; and

allowed length increase=strength factor*allowed length change,

where allowed length decrease is the value of the allowed length decrease field, allowed length increase is the value of the allowed length increase field, strength factor is the value of the strength factor field (expressed as a value between 0 and 1 or a percentage between 0 and 100), and allowed length change is the value of the allowed length of change field. The bat selection module 12 may round the values of the allowed length decrease field and the allowed length increase field to the nearest tenth in various implementations.

The graphical user interface 18 also includes an allowed weight decrease field “−weight” and an allowed weight increase field “+weight”. The value of the allowed weight decrease field indicates a maximum allowed decrease in weight relative to the baseline bat weight. In other words, the value of the allowed weight decrease field indicates a maximum allowed amount that the final suggested bat weight can be less than the between the baseline bat weight. The value of the allowed weight increase field indicates a maximum allowed increase in weight relative to the baseline bat weight. In other words, the value of the allowed weight increase field indicates a maximum allowed amount that the final suggested bat weight can be greater than the between the baseline bat weight. The bat selection module 12 sets the values of the allowed weight decrease field and the allowed weight increase field based on the value of the strength factor field and the value of the allowed weight change field. The bat selection module 12 may set the values of the allowed weight decrease field and the allowed weight increase field, for example, using one or more functions or equations that relate values of the strength factor field to values of the allowed weight decrease field and the allowed weight increase field. For example, the bat selection module 12 may set the values of the allowed weight decrease field and the allowed weight increase field using the equations:

allowed weight decrease=1−strength factor*allowed weight change; and

allowed weight increase=strength factor*allowed weight change,

where allowed weight decrease is the value of the allowed weight decrease field, allowed weight increase is the value of the allowed weight increase field, strength factor is the value of the strength factor field (expressed as a value between 0 and 1 or a percentage between 0 and 100), and allowed weight change is the value of the allowed weight of change field. The bat selection module 12 may round the values of the allowed weight decrease field and the allowed weight increase field to the nearest tenth in various implementations.

The graphical user interface 18 may also include an allowed MOI decrease field “−MOI” and an allowed MOI increase field “+MOI”. The value of the allowed MOI decrease field indicates a maximum allowed decrease in MOI relative to the athlete's present bat. In other words, the value of the allowed MOI decrease field indicates a maximum allowed amount that the MOI of the final suggested bat can be less than the between the MOI of the athlete's present bat. The value of the allowed MOI increase field indicates a maximum allowed increase in MOI relative to the MOI of the athlete's present bat. In other words, the value of the allowed MOI increase field indicates a maximum allowed amount that the MOI of the final suggested bat can be greater than the MOI of the baseline bat. The bat selection module 12 sets the values of the allowed MOI decrease field and the allowed MOI increase field based on the value of the strength factor field and the value of the allowed MOI change field. The bat selection module 12 may set the values of the allowed MOI decrease field and the allowed MOI increase field, for example, using one or more functions or equations that relate values of the strength factor field to values of the allowed MOI decrease field and the MOI weight increase field. For example, the bat selection module 12 may set the values of the allowed MOI decrease field and the allowed MOI increase field using the equations:

allowed MOI decrease=1−strength factor*allowed MOI change; and

allowed MOI increase=strength factor*allowed MOI change,

where allowed MOI decrease is the value of the allowed MOI decrease field, allowed MOI increase is the value of the allowed MOI increase field, strength factor is the value of the strength factor field (expressed as a value between 0 and 1 or a percentage between 0 and 100), and allowed MOI change is the value of the allowed MOI of change field. The bat selection module 12 may round the values of the allowed MOI decrease field and the allowed MOI increase field to the nearest tenth in various implementations.

The graphical user interface 18 also includes prioritization fields for user selection of performance characteristics to be adjusted and relative adjustments of those parameters. Examples of adjustments include “a lot more”, “a little more”, “hold”, “a little less”, and “a lot less”. However, other example adjustments may be used. The indicator of an adjustment field indicates a desired relative adjustment of the associated performance characteristic. The performance characteristics are discussed above and include, for example, bat speed, hand speed, time to contact (TTC), bat angle, exit velocity, smash factor, launch angle, spin rate, and direction angle.

For example, the graphical user interface 18 includes a first priority adjustment field and a first priority performance characteristic field. In the example of FIG. 2C, the first priority adjustment field is set to “a lot more” and the first priority performance characteristic is set to “bat speed”. The graphical user interface 18 includes a second priority adjustment field and a second priority performance characteristic field. In the example of FIG. 2C, the second priority adjustment field is set to “hold” and the second priority performance characteristic is set to “smash,” as in smash factor. The graphical user interface 18 includes a third priority adjustment field and a third priority performance characteristic field. In the example of FIG. 2C, the third priority adjustment field is set to “a little less” and the third priority performance characteristic is set to “time to contact”. The priority dictates the priority of the adjustment of the selected performance characteristics. For example, in the example of FIG. 2C, adjusting bat speed will be given priority over adjusting smash factor, and adjusting smash factor will be given priority of adjusting time to contact.

The bat selection module 12 determines the final suggested bat length based on the baseline bat length, the indicators of the priority adjustment fields and the priority performance characteristic fields, the associated performance characteristics, and the value of the allowed length decrease field, and the value of the allowed length increase field. For example, the bat selection module 12 may determine the final suggested bat length, for example, using one or more lookup tables or equations that relate baseline bat lengths, values corresponding to the indicators of the priority adjustment fields, and values corresponding to changes to adjust the respective performance characteristics by predetermined amounts to final suggested bat lengths. For example only, the bat selection module 12 may determine the final suggested bat length using the equation:

Final=baseline+(P1 scalar*Modifier scalar 1*modifier 1)+(P2 scalar*Modifier scalar 2*modifier 2)+(P3 scalar*Modifier scalar 3*modifier 3),

where Final is the final suggested bat length, baseline is the baseline bat length, P1 scalar is a predetermined scalar value corresponding to a first (highest) priority (e.g., 60%, 0.6), Modifier scalar 1 is a predetermined value corresponding to the indicator of the first priority adjustment field, modifier 1 is a value corresponding to a change to adjust the first performance characteristics by a predetermined amount. P2 scalar is a predetermined scalar value corresponding to a second (highest) priority (e.g., 30%, 0.3), Modifier scalar 2 is a predetermined value corresponding to the indicator of the second priority adjustment field, modifier 2 is a value corresponding to a change to adjust the second performance characteristics by a predetermined amount. P3 scalar is a predetermined scalar value corresponding to a third (highest) priority (e.g., 10%, 0.1), Modifier scalar 3 is a predetermined value corresponding to the indicator of the third priority adjustment field, modifier 3 is a value corresponding to a change to adjust the third performance characteristics by a predetermined amount. The bat selection module 12 may determine the modifier 1, modifier 2, and modifier 3 based on the first, second, and third performance characteristics, respectively.

While examples of the predetermined scalar values are provided, other predetermined scalar values may be used. Also, while the example of three priorities is provided, a greater or fewer number of prioritized performance characteristics may be provided. Also, if no user input is received for a possible performance characteristic field, the predetermined scalar value for that field may be set to zero and distributed to other (populated) fields. Example predetermined values a priority adjustment field indicative of “a lot more”, “a little more”, “hold”, “a little less”, and “a lot less” include 1, 0.33, 0, −0.33, and −1, respectively. However, other predetermined values and/or indicators of adjustments may be used.

The bat selection module 12 also limits the final suggested bat length to within the value of the allowed length increase field and the value of the allowed length decrease field of the baseline bat length. In other words, if the final suggested bat length is greater than the baseline bat length plus the value of the allowed length increase field, the bat selection module 12 sets the final suggested bat length to the baseline bat length plus the value of the allowed length increase field. If the final suggested bat length is less than the baseline bat length minus the value of the allowed length decrease field, the bat selection module 12 sets the final suggested bat length to the baseline bat length minus the value of the allowed length decrease field. If the final suggested bat length is between (1) the baseline bat length minus the value of the allowed length decrease field and (2) the baseline bat length plus the value of the allowed length increase field, the bat selection module 12 leaves the final suggested bat length unchanged.

The bat selection module 12 displays the final suggested bat length on the graphical user interface under a final suggested bat length field (“length”). In the example of FIG. 2C, the final suggested bat length is 31.6 inches as shown under the final suggested bat length field.

The bat selection module 12 determines the final suggested bat weight based on the baseline bat weight, the indicators of the priority adjustment fields and the priority performance characteristic fields, the associated performance characteristics, and the value of the allowed weight decrease field, and the value of the allowed weight increase field. For example, the bat selection module 12 may determine the final suggested bat weight, for example, using one or more lookup tables or equations that relate baseline bat weights, values corresponding to the indicators of the priority adjustment fields, and values corresponding to changes to adjust the respective performance characteristics by predetermined amounts to final suggested bat weights. For example only, the bat selection module 12 may determine the final suggested bat weight using the equation:

Final W=baseline W+(P1 scalar*Modifier scalar 1*modifier 1)+(P2 scalar*Modifier scalar 2*modifier 2)+(P3 scalar*Modifier scalar 3*modifier 3),

where Final W is the final suggested bat weight, baseline W is the baseline bat weight, P1 scalar is a predetermined scalar value corresponding to a first (highest) priority (e.g., 60%, 0.6), Modifier scalar 1 is a predetermined value corresponding to the indicator of the first priority adjustment field, modifier 1 is a value corresponding to a change to adjust the first performance characteristics by a predetermined amount. P2 scalar is a predetermined scalar value corresponding to a second (highest) priority (e.g., 30%, 0.3), Modifier scalar 2 is a predetermined value corresponding to the indicator of the second priority adjustment field, modifier 2 is a value corresponding to a change to adjust the second performance characteristics by a predetermined amount. P3 scalar is a predetermined scalar value corresponding to a third (highest) priority (e.g., 10%, 0.1), Modifier scalar 3 is a predetermined value corresponding to the indicator of the third priority adjustment field, modifier 3 is a value corresponding to a change to adjust the third performance characteristics by a predetermined amount. The bat selection module 12 may determine the modifier 1, modifier 2, and modifier 3 based on the first, second, and third performance characteristics, respectively.

While examples of the predetermined scalar values are provided, other predetermined scalar values may be used. Also, while the example of three priorities is provided, a greater or fewer number of prioritized performance characteristics may be provided. Also, if no user input is received for a possible performance characteristic field, the predetermined scalar value for that field may be set to zero and distributed to other (populated) fields. Example predetermined values a priority adjustment field indicative of “a lot more”, “a little more”, “hold”, “a little less”, and “a lot less” include 1, 0.33, 0, −0.33, and −1, respectively. However, other predetermined values and/or indicators of adjustments may be used.

The bat selection module 12 also limits the final suggested bat weight to within the value of the allowed weight increase field and the value of the allowed weight decrease field of the baseline bat length. In other words, if the final suggested bat weight is greater than the baseline bat weight plus the value of the allowed weight increase field, the bat selection module 12 sets the final suggested bat weight to the baseline bat weight plus the value of the allowed weight increase field. If the final suggested bat weight is less than the baseline bat weight minus the value of the allowed length weight field, the bat selection module 12 sets the final suggested bat weight to the baseline bat weight minus the value of the allowed weight decrease field. If the final suggested bat weight is between (1) the baseline bat weight minus the value of the allowed weight decrease field and (2) the baseline bat weight plus the value of the allowed weight increase field, the bat selection module 12 leaves the final suggested bat weight unchanged.

The bat selection module 12 displays the final suggested bat weight on the graphical user interface under a final suggested bat weight field (“WT”). In the example of FIG. 2C, the final suggested bat weight is 21.5 ounces as shown under the final suggested bat weight field.

The bat selection module 12 determines a suggested bat based on the final suggested bat length and the final suggested bat weight. For example, the bat selection module 12 may select the suggested bat from a lookup table of bats indexed by bat length and weight as the one of the bats of the lookup table that is closest in length and weight to the final suggested bat weight and the final suggested bat length. The bat selection module 12 displays an identifier of the suggested bat (e.g., a model number) on the graphical user interface under a suggested bat field (“Model”). In the example of FIG. 2C, the suggested bat is identified as 271 (e.g., Model 271) as shown under the suggested bat field. The lookup table of bats may include various bat lengths with one-half inch length increments (e.g., . . . 31″, 31.5″, 32″, 32.5″ . . . ), one-quarter inch length increments (e.g., . . . 31″, 31.25″, 31.5″, 31.75″, 32″, 32.25″, 32.5″ . . . ), or another suitable bat length increment.

In various implementations, upon receipt of user input indicative of an acceptance of the suggested bat, the bat selection module 12 may machine a bat having the final suggested bat length and the final suggested bat weight. The bat selection module 12 may machine a bat by, for example, shaping a raw piece of wood using an automated lathe to have the final suggested bat length, and the final suggested bat weight, and geometric/diametric profile, three-dimensional (3D) printing a bat having the final suggested bat length, the final suggested bat weight, and geometric/diametric profile using a 3D printer, forming metal into a bat having the final suggested bat length, the final suggested bat weight, and geometric/diametric profile using one or more metal forming tools, or in another suitable manner. In various implementations, custom tooling may be used to mold, trim, and create a custom bad to the final suggested bat length, the final suggested bat weight, and geometric/diametric profile.

Generally speaking, the present application assists consumers in directly communicating their performance goals while optimizing, calculating, and prescribing a bat configuration that provides an opportunity to improve desired performance for the athlete based upon their age, size, strength, skill, and swing/impact/ballflight tendencies.

Specific performance goals (or characteristics) may include bat speed, bat path, ball exit velocity, three-dimensional ball flight trajectory bias, three-dimensional ball flight trajectory standard deviation, hand speed, impact efficiency, plate coverage, ball spin rate, ball spin axis, body kinematics, and pitch specific performance for each of these metrics. The present application solves for the additive variable contribution to an optimal bat configuration to match the stated performance goals of the athlete. The result is fewer guess and check cycles for the athlete, and a more precise, customized solution.

With a near infinite set of mass, geometry, flexural, energy transfer, friction, acoustic, aesthetic, tactile and other property combinations possible in the configuration of a bat, original equipment manufacturers offer a multitude of pre-formulated solutions to the consumer. This may be quantified by the number of unique stock keeping units (SKUs) for a given brand and/or product family. While a large, unique product inventory provides the consumer with many options, it may be a challenge for the consumer to communicate their specific desires and to navigate the inventory to find the best product for them. Secondly, larger retail inventories present management challenges for the retailer. The present application aids a professional bat fitter, coach, parent and athlete in the data-driven navigation, testing, selection and ordering of a bat offering arriving at the optimal configuration as a function of the unique performance goals and performance of the athlete/consumer. The result is fewer SKUs at retail and a more precise fit without a trial and error fitting process.

Bat fitting may alternatively be achieved by recommending a bat length based solely on the size of the athlete considering only height and weight. The weight of the bat is governed by the league or association as a maximum “drop” or delta between the length measured in inches and the mass measured in ounces. The opportunity exists to utilize measurements of physical size, strength, speed, swing biomechanics, and/or current performance of the athlete to prescribe an optimal bat configuration for the prioritized performance goals.

The present application provides a guided software tool to assist coaches, parents, athletes, and sales or fitting representatives in the communication of their performance targets and the data-driven selection of the optimal bat configuration or “fit.” The performance target is created by the consumer(s) with or without the assistance of a fitting representative via survey questions, answers to a range of preferences, and/or a fitting algorithm. As an example, the consumer(s) may be asked for their prioritized preferences targeting improvements in metrics such as but not limited to bat speed, ball exit velocity, three-dimensional ball flight trajectory bias, three-dimensional ball flight trajectory standard deviation, hand speed, impact efficiency, plate coverage, ball spin rate, ball spin axis, and pitch specific performance. Prioritized performance targets are first scaled according to preference. Secondly, a modifier such as but not limited to “a little less,” “a lot more,” “no change” or similar is used to define the desired amount of improvement for each chosen metric. These modifiers may also result in a scalar within the algorithm or method. Lastly, the scalars are multiplied by additive incremental changes to physical specifications (plus or minus) that have correlations to each performance target.

A baseline fit is driven by the age, association, drop weight, and/or the size of the player including height, weight, and wingspan or reach. A final suggested fit is allowed to vary up or down from the baseline fit by a set range which varies up or down based upon the measured strength and skill of the athlete.

As an example, if a baseline fit recommends a 30″ bat at drop 10 which is equal to 20 ounces, the present application may allow for the final suggested bat length to be as much as a 2″ delta or 1″ shorter or 1″ longer than the baseline 30″ fit. A calculated strength or skill of the athlete may shift this range from 2″ shorter to no change or, conversely, to no change to 2″ longer. The same logic may be used for mass or geometric properties of the bat.

Once the range of allowed variation is established, prioritized performance targets drive the algorithm to add scaled, cumulative changes to the specifications. As an example, if there are 3 prioritized targets, the first priority could be weighted at 60%, the second priority could be weighted at 30%, and the third priority could be weighted at 10%. If a priority is given a directional modifier of “a little less,” it may be scaled by −0.33. Conversely, “a lot more” could produce a scalar of 1.

Each target metric corresponds to a series of specification modifications that correlate to directional changes in performance. As an example, if a player is looking to increase bat speed, a 1″ shorter, 1 ounce lighter, and 300 pts of MOI lower bat relative to the baseline fit may be suggested. With each performance priority, a different set of spec modifications is suggested, scaled by priority and magnitude, and added incrementally to the original baseline fit.

An example of this equation for each individual spec with n, scaled priorities may look similar to

Final Fit=Baseline fit+(P1 Scalar %*mod. scalar*modifier)+(P2 Scalar %*mod. scalar*modifier)+(Pn Scalar %*mod. scalar*modifier)+ . . . , as described above.

As each priority may pull the fit in an opposite direction from a previous priority. It may be possible to add both positive and negative scaled modifiers within this equation. Once each spec is prescribed, the system may search a SKU inventory to find the nearest (or closest matching) bat configuration. A user may use an application or software to communicate with the consumer throughout the fitting process. Alternatively, the consumer may input their prioritized performance target and athlete test data directly into an app or software which runs the algorithm and provides a virtual fitting experience.

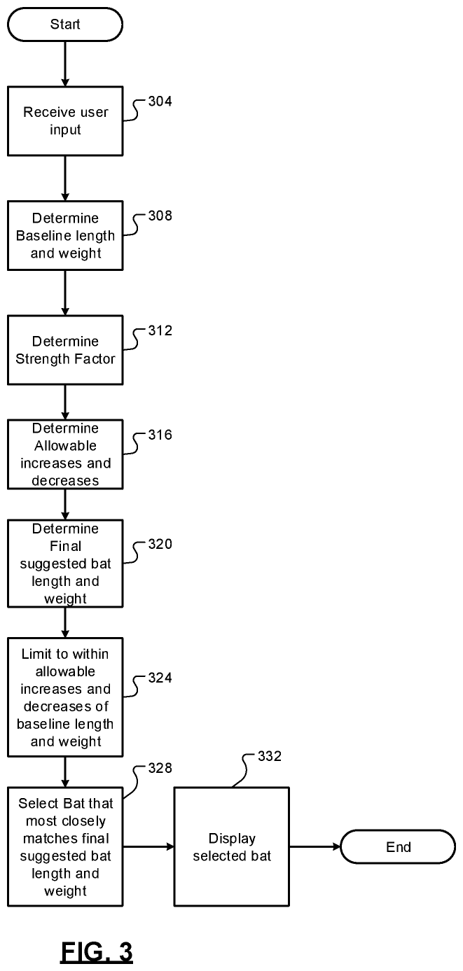

FIG. 3 includes a flowchart depicting an example method of providing bat suggestions and suggesting a bat for use by an athlete. At 304, the bat selection module 12 receives user input to the graphical user interface 18. At 308, the bat selection module 12 determines the baseline bat length and the baseline bat weight based on the athlete's height and weight.

At 312, the bat selection module 12 determines the strength factor value of the athlete based on the user input to the graphical user interface 18. At 316, the bat selection module 12 determines the allowable increases and decreases based on the baseline increases and decreases and the strength factor value of the athlete. At 320, the bat selection module 12 determines the final suggested bat length and the final suggested bat weight based on the baseline bat length and weight, the priorities, the desired adjustments, and the predetermined values, as discussed above.

At 324, the bat selection module 12 limits the final suggested bat length and weight to be within the allowable increases and decreases of the baseline bat length and weight, respectively. At 328, the bat selection module 12 selects one of the bats that most closely matches the final suggested bat length and weight. The bat selection module 12 displays the final suggested bat length and weight and the selected bat on the graphical user interface 18 at 332.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON

(JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A bat fitting system for fitting a bat to an athlete, the bat fitting system comprising:
a host control module configured to generate a graphical user interface (GUI) for display on a display, the GUI including:
an age field for input indicative of a present age of the athlete;
a height field for input indicative of a present height of the athlete;
a weight field for input indicative of a present weight of the athlete;
an association field for input indicative of one of a league and a group with which the athlete is affiliated;
a bat selection module configured to:
determine a target drop for bats for the athlete based on data in the association field;
determine a suggested bat length for the athlete based on data in the age, height, weight, and association fields; and
determine a suggested bat weight based on the suggested bat length minus the target drop; and
select one of a plurality of bats based on the suggested bat length and the suggested bat weight,
wherein the host control module is further configured to display the selected one of the plurality of bats on the GUI.

2. The bat fitting system of claim 1 wherein the bat selection module is configured to determine the suggested bat length using one of a lookup table and an equation that relates ages, heights, and weights for affiliations to suggested bat lengths.

3. The bat fitting system of claim 1 wherein the bat selection module is configured to set the target drop using a lookup table that relates possible affiliations in the association field to target drops.

4. The bat fitting system of claim 1 wherein:
the GUI further includes:
a priority adjustment field for input indicative of a parameter of the athlete to prioritize; and
a priority performance characteristic field for input indicative of an extent to improve the parameter to prioritize;
wherein the bat selection module is further configured to:
determine a final suggested bat length based on the suggested bat length, the parameter to prioritize, and a predetermined value corresponding to the input indicative of the extent to improve the parameter to prioritize; and
select one of the plurality of bats based on the final suggested bat length; and
wherein the host control module is further configured to display the final suggested bat length on the GUI.

5. The bat fitting system of claim 4 wherein the bat selection module is configured to determine the final suggested bat length based on:
baseline+(P1 scalar*Modifier scalar 1*modifier 1)
where baseline is the suggested bat length, P1 scalar is a predetermined scalar value, Modifier scalar 1 is the predetermined value corresponding to the input indicative of the extent to improve the parameter to prioritize, and modifier 1 is a predetermined value corresponding to a change in bat length to adjust the parameter by a predetermined amount.

6. The bat fitting system of claim 1 wherein:
the GUI further includes:
a priority adjustment field for input indicative of a parameter of the athlete to prioritize; and
a priority performance characteristic field for input indicative of an extent to improve the parameter to prioritize;
wherein the bat selection module is further configured to:
determine a final suggested bat weight based on the suggested bat weight, the parameter to prioritize, and a predetermined value corresponding to the input indicative of the extent to improve the parameter to prioritize; and
select one of the plurality of bats based on the final suggested bat weight; and
wherein the host control module is further configured to display the final suggested bat weight on the GUI.

7. The bat fitting system of claim 6 wherein the bat selection module is configured to determine the final suggested bat weight based on:
baseline+(P1 scalar*Modifier scalar 1*modifier 1)
where baseline is the suggested bat weight, P1 scalar is a predetermined scalar value, Modifier scalar 1 is the predetermined value corresponding to the input indicative of the extent to improve the parameter to prioritize, and modifier 1 is a predetermined value corresponding to a change in bat weight to adjust the parameter by a predetermined amount.

8. The bat fitting system of claim 1 wherein:
the GUI further includes:
a priority adjustment field for input indicative of a parameter of the athlete to prioritize; and
a priority performance characteristic field for input indicative of an extent to improve the parameter to prioritize;
wherein the bat selection module is further configured to:
determine a final suggested bat length based on the suggested bat length, the parameter to prioritize, and a predetermined value corresponding to the input indicative of the extent to improve the parameter to prioritize;
determine a final suggested bat weight based on the suggested bat weight, the parameter to prioritize, and the predetermined value corresponding to the input indicative of the extent to improve the parameter to prioritize; and
select one of the plurality of bats based on the final suggested bat length; and
wherein the host control module is further configured to display the final suggested bat length and the final suggested bat weight on the GUI.

9. The bat fitting system of claim 8 wherein the bat selection module is configured to:
determine the final suggested bat length based on:
baseline l+(P1l scalar*Modifier scalar 1*modifier 1l)
where baseline l is the suggested bat length, P1l scalar is a predetermined length scalar value, Modifier scalar 1 is the predetermined value corresponding to the input indicative of the extent to improve the parameter to prioritize, and modifier 1l is a first predetermined value corresponding to a change in bat length to adjust the parameter by a first predetermined amount; and
determine the final suggested bat weight based on:
baseline w+(P1w scalar*Modifier scalar 1*modifier 1w)
where baseline w is the suggested bat weight, P1w scalar is a predetermined weight scalar value, Modifier scalar 1 is the predetermined value corresponding to the input indicative of the extent to improve the parameter to prioritize, and modifier 1w is a second predetermined value corresponding to a change in bat weight to adjust the parameter by a second predetermined amount.

10. The bat fitting system of claim 8 wherein:
the graphical user interface further includes a bat speed field for input indicative of a bat speed of the athlete; and
the parameter of the athlete to prioritize includes bat speed.

11. The bat fitting system of claim 8 wherein:
the graphical user interface further includes a hand speed field for input indicative of a hand speed of the athlete; and
the parameter of the athlete to prioritize includes hand speed.

12. The bat fitting system of claim 8 wherein:
the graphical user interface further includes a time to contact field for input indicative of a time to contact of the athlete; and
the parameter of the athlete to prioritize includes time to contact.

13. The bat fitting system of claim 8 wherein:
the graphical user interface further includes a bat angle field for input indicative of a bat angle of the athlete; and
the parameter of the athlete to prioritize includes bat angle.

14. The bat fitting system of claim 8 wherein:
the graphical user interface further includes an exit velocity field for input indicative of a exit velocity of the athlete; and
the parameter of the athlete to prioritize includes exit velocity.

15. The bat fitting system of claim 8 wherein:
the graphical user interface further includes a smash factor field for input indicative of a smash factor of the athlete; and
the parameter of the athlete to prioritize includes smash factor.

16. The bat fitting system of claim 8 wherein:
the graphical user interface further includes a launch angle field for input indicative of a launch angle of a ball at impact of the athlete; and
the parameter of the athlete to prioritize includes launch angle.

17. The bat fitting system of claim 8 wherein:
the graphical user interface further includes a spin rate field for input indicative of a spin rate of a ball after impact of the athlete; and
the parameter of the athlete to prioritize includes spin rate.

18. The bat fitting system of claim 8 wherein:
the graphical user interface further includes a flight angle field for input indicative of a flight angle of a ball after impact of the athlete; and
the parameter of the athlete to prioritize includes flight angle.

19. The bat fitting system of claim 8 wherein:
the GUI further includes:
a second priority adjustment field for input indicative of a second parameter of the athlete to prioritize; and
a second priority performance characteristic field for second input indicative of an extent to improve the second parameter to prioritize; and
wherein the bat selection module is further configured to:
determine the final suggested bat length based on the suggested bat length, the parameter to prioritize, the second parameter to prioritize, the predetermined value corresponding to the input indicative of the extent to improve the parameter to prioritize, and a second predetermined value corresponding to the second input indicative of the extent to improve the second parameter to prioritize; and
determine a final suggested bat weight based on the suggested bat length, the parameter to prioritize, the second parameter to prioritize, the predetermined value corresponding to the input indicative of the extent to improve the parameter to prioritize, and a second predetermined value corresponding to the second input indicative of the extent to improve the second parameter to prioritize.

20. The bat fitting system of claim 19 wherein the bat selection module is configured to:
determine the final suggested bat length based on:
baseline l+(P1l scalar*Modifier scalar 1* modifier 1l)+(P2l scalar*Modifier scalar 2*modifier 2l)
where baseline l is the suggested bat length, P1l scalar is a first predetermined length scalar value, Modifier scalar 1 is the predetermined value corresponding to the input indicative of the extent to improve the parameter to prioritize, modifier 1l is a third predetermined value corresponding to a change in bat length to adjust the parameter by a first predetermined amount, P2l scalar is a second predetermined length scalar value, Modifier scalar 2 is the second predetermined value corresponding to the second input indicative of the extent to improve the second parameter to prioritize, and modifier 2l is a fourth predetermined value corresponding to a change in bat length to adjust the second parameter by a second predetermined amount; and
determine the final suggested bat weight based on:
baseline w+(P1w scalar*Modifier scalar 1*modifier 1w)+(P2w scalar*Modifier scalar 2*modifier 2w)
where baseline l is the suggested bat weight, P1w scalar is a first predetermined weight scalar value, Modifier scalar 1 is the predetermined value corresponding to the input indicative of the extent to improve the parameter to prioritize, modifier 1w is a fifth predetermined value corresponding to a change in bat length to adjust the parameter by a third predetermined amount, P2w scalar is a second predetermined weight scalar value, Modifier scalar 2 is the second predetermined value corresponding to the second input indicative of the extent to improve the second parameter to prioritize, and modifier 2w is a sixth predetermined value corresponding to a change in bat length to adjust the second parameter by a fourth predetermined amount.

21. A method for fitting a bat to an athlete, the method comprising:
by one or more processors, generating a graphical user interface (GUI) for display on a display, the GUI including:
an age field for input indicative of a present age of the athlete;
a height field for input indicative of a present height of the athlete;
a weight field for input indicative of a present weight of the athlete;
an association field for input indicative of one of a league and a group with which the athlete is affiliated;
by the one or more processors, determining a target drop for bats for the athlete based on data in the association field;
by the one or more processors, determining a suggested bat length for the athlete based on data in the age, height, weight, and association fields;
by the one or more processors, determining a suggested bat weight based on the suggested bat length minus the target drop;
by the one or more processors, selecting one of a plurality of bats based on the suggested bat length and the suggested bat weight; and
by the one or more processors, displaying the selected one of the plurality of bats on the GUI.
